(19) United States
(12) Patent Application Publication
(10) Pub. No.: US 2001/0037468 A1
(43) Pub. Date: Nov. 1, 2001

(54) Method and apparatus for creating unique image passwords

(76) Inventor: M. Norton Gaddis, Topeka, KS (US)

Correspondence Address: WRIGHT, HENSON, SOMERS, SEBELIUS,, CLARK & BAKER, LLP, 100 E. 9th Street, 2nd Floor, P. O. Box 3555, Topeka, KS, 66601-3555, US

(21) Appl. No.: 09/829,723

(22) Filed: Apr. 10, 2001

Related U.S. Application Data
(60) Provisional application No. 60/196,456, filed on Apr. 11, 2000.

(51) Int. Cl. H04L 9/32

(52) U.S. Cl. 713/202

(57) ABSTRACT

A method for creating unique digitized image passwords comprised of creating the digitized image as a password to enable access to the computer, storing the digitized image password on keypad removable storage means, assigning a separate numerical key or sequence of numbers to the digitized image password on the keypad device, inserting the digitized image password on the removable storage means into the keypad device when access to the computer is desired, inserting the numeric code or sequence, comparing the code sequence with the digitized image, comparing the digitized image with the digitized image stored on the computer storage means, and if a match is obtained, enabling access to the computer.

### BACKGROUND OF INVENTION

This invention is directed to the art of computer security. In recent years, security of computers has become significantly important, not only because of the proliferation of the use of computers, but also with the rise of interest in the Internet and potential access to individual computers from the Internet. Current and popular password schemes are often compromised due to an Internet hacker's knowledge that the characters making up the password are universal on every standard keyboard, since most keyboards utilize the common ASCII code.

The current invention is intended to take advantage of currently available graphic programs and utilize a keypad device with keypad and computer disc “keys” that allow for specific detailed graphical key images stored thereon that would be difficult, if not next to impossible, to recreate by typical trial and error.

The current invention utilizes color digital images, graphic images commonly available by design or by scanning in (such as utilizing a picture of one's own pet) that become passwords unique to the user. Paint programs and scanner programs that are readily available on nearly all computer platforms work compatibly with the instant invention to allow use of graphic image passwords.

The envisioned keypad device is comprised of an external numeric keypad, a display, a removable media device (for example floppy disks or CD Roms) that will have discs that act as “keys” having the graphic images thereon, and internal memory. The keypad device has non-volatile internal memory capable of storing the graphic image password once it is created by the user, and in fact in the preferred mode, the graphic user password is comprised of a series of images that are stored in the device with each image assigned to a key (O through 9) on the device in a sequence specified by the user. This sequence is then replayed with the disk in place, to enable access to the computer. As a secondary security measure, the computer floppy drive or removable storage device will have placed therein its own floppy disk or CD Rom with a second graphic password (or non-image, if preferred) assigned to the computer keyboard, in a sequence fashioned much like the keypad device, such that the keypad device password and the computer password are necessary to gain access to the computer. These two passwords help prevent a would-be intruder otherwise placing his own keypad device that would otherwise send a “go” code to the computer.

Consequently, the user must have a disk having both passwords thereon (or two separate disks) with images that match the images stored in memory loaded in the media device each time the log-in attempt is tried or whenever the computer is powered up. In the alternative mode, the media device would also be able to be shared on a network through the input/output port.

The external keypad device will store both the images in password sequence and thus validate the sequence typed by the user attempting to gain access. In the preferred mode of the invention, multiple failed accesses will disable the computer for a period of time.

The external keypad device is further designed to connect to a standard computer through the many different interfaces available, including serial, parallel, ethernet, keyboard ports, and USB ports.

Consequently it will be seen that what is shown is an ultra secure highly personalized password device and method that allows a user not only to have the user's own selected graphical keywords, but also allows the use of current graphical programs and utilizes the computer's current input/output ports, and further creates a highly secure apparatus and method.

Other objects and features of the invention and the manner in which the invention achieves its purpose will be appreciated from the foregoing and the following description and the accompanying drawings which exemplify the invention, it being understood that changes may be made in the specific method and apparatus disclosed herein without departing from the essentials of the invention set forth in the appended claims.

### DESCRIPTION OF THE DRAWINGS

FIG. 1 is a shows the computer system and the keypad device.

FIG. 2 is a block diagram of the keypad device connected to the block diagram of the computer system.

FIG. 3 is a block diagram of the computer program modules for the invention.

FIG. 4 is a flow chart for loading the respective image password.

FIG. 5 is a block diagram of a flow chart for gaining access to the computer system through the keypad device utilizing the password and password sequence.

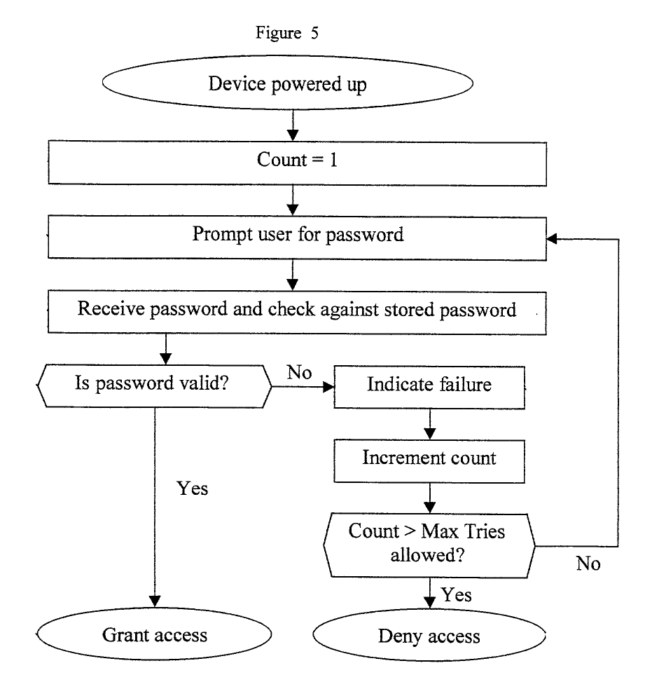

### DESCRIPTION OF THE PREFERRED EMBODIMENT

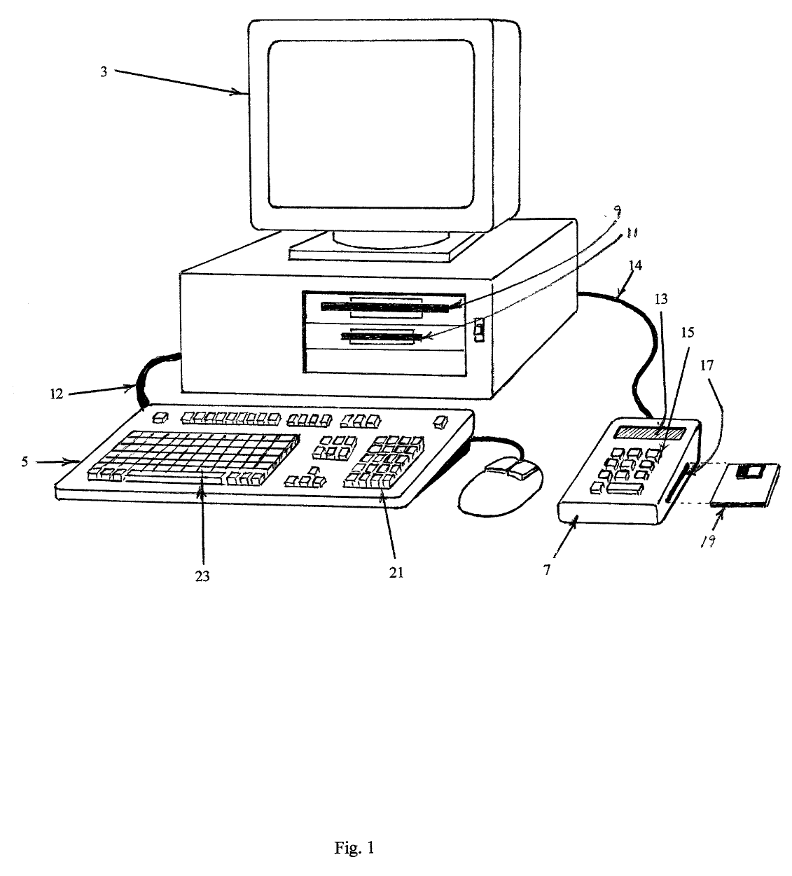

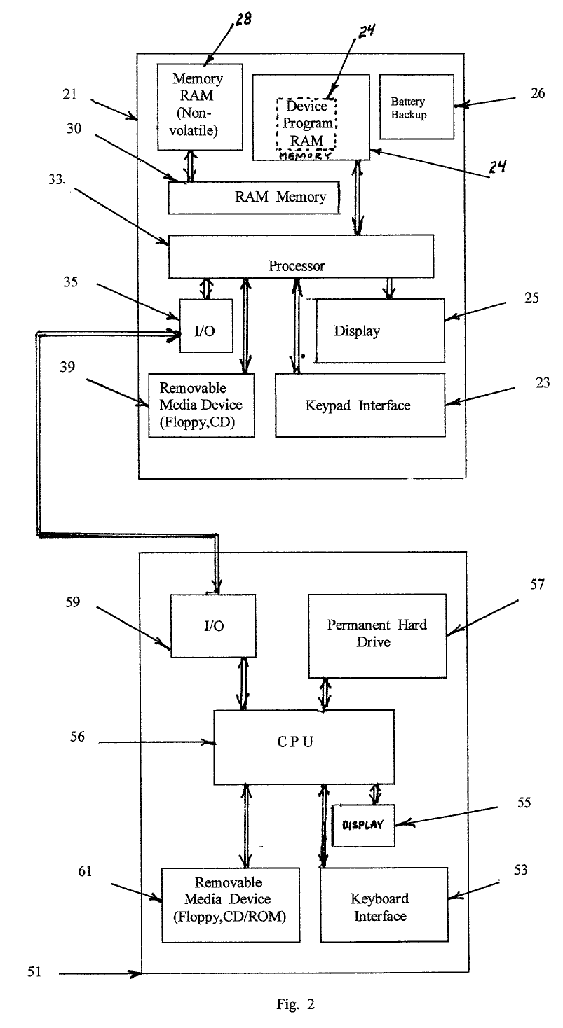

The apparatus is shown in FIG. 1 in the preferred mode and in block diagram form in FIG. 2. In FIG. 1, the keypad device 7 is shown in the preferred form adjacent to the computer keyboard 5 although any particular placement is envisioned that allows easy access by the user. The term Keypad Device is used herein refers to the physically separate device shown in FIG. 1. Keyboard as used herein refers to the computer keyboard 5.

The keyboard device 7 has display means 13 for displaying alphanumeric figures for prompting the user and for displaying status. Push button keys 15 are essentially the standard 0-9 keys along with any desired extra keys that may be envisioned to carry out the program on the device. The keypad device also has floppy disk or other removable storage means 17. The floppy disk 19 is shown, however, it should be understood that any removable storage device is envisioned including CD Roms.

The device is connected via cable 14 to the computer input/output ports. These can be any standard computer input/output ports including parallel, serial, ethernet or even standard USB ports. In the preferred mode, the standard USB port is envisioned.

The computer system is comprised of a standard PC, but can be any computer system having the block diagram content shown in FIG. 2. The computer system is comprised of a monitor 3, computer with motherboard, input/output port, internal hard drive or other permanent storage means, with CD Rom 9 and/or floppy disk media device 11, and further has a typical keyboard 5 having alphanumerical keys 23 and a numeric keypad 21. The keyboard is connected to the computer via cable 12. A mouse is also envisioned and is commonly used to construct any images in typical paint or other graphic display programs.

It should be understood that graphic display programs, include those programs commonly available on the market such as paint programs like MICROSOFT PAINT, COREL DRAW, ADOBE, and also includes scanner programs and the ability to scan in to the computer any images from a separate scanner device.

The block diagram shown in FIG. 2 has two portions, the computer block diagram 51 and the keypad device block diagram 21. The keypad device 21 has input/output means 35, removable media device 39 (shown as 17 in FIG. 1), keypad interface 23 (shown as 15 in FIG. 1), display means 25 (shown as 13 in FIG. 1), all interfacing with the central processing unit 33. RAM memory 30 also interfaces with the processor as does non-volatile memory 28 (for receiving and permanently storing device image passwords). ROM memory 24 has therein the device program memory stored necessary to operate the keypad device. Permanent battery means 26 is electrically connected to the RAM memory to the extent the memory requires constant voltage. However, other non-volatile memory means are envisioned for 28 including magnetic cards or rewritable storage media.

The keyboard device is connected to the computer in FIG. 2 via cable 37 showing the connections between the respective input/output devices 35 and 59. The computer block diagram 51 reflects a fairly standard computer block diagram having a CPU, controlling the various parts including the permanent hard drive 57, display means 55, keyboard interface 53 and removable means device 61. The removable media device 61 can be any removable media device capable of storing the respective computer image password envisioned by the inventor. The permanent hard drive 57 can be any magnetic or other media storing internally the corresponding computer password image that will match and correspond to that on the removable media device disk 61.

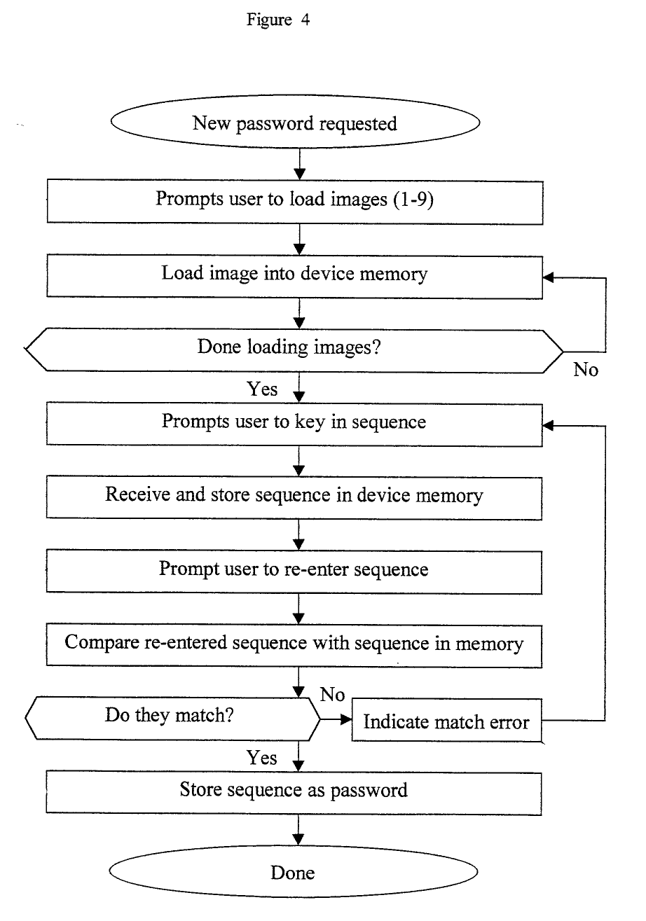

In use, the computer program is installed initially on the computer on the permanent hard drive 57 and once installed, need not be used again so long as the program remains stored on the permanent hard drive. In the installation process, the program accesses the internal computer user definable startup programs and installs the necessary code to direct the user at startup to the security startup screen. In MS-DOS based PC's for example, the AUTOEXEC.BAT file and the CONFIG. SYS file might be used, although other methods of directing the user to the security login screen are envisioned. The object is to insert the proper code to draw up the program upon computer star before allowing any further access to the computer, and also prior to any log-in attempt if the computer is connected to a network. If the inventive process is utilized to prevent access to specific programs, or even the internet, the access modules of those programs are revised to insert the proper code to direct the user to the security login screen. In essence, the computer program or the device is comprised of four essential modules, an installation module utilized for installing the program initially, an initialize/recognize module that is readily on call when the computer is turned on for signing on, a create/edit module that allows for creation or editing of image passwords and provides for calling up of standard paint or other graphic image programs, and a store/download module for storing the selected passwords in the respective computer/keypad permanent memory and also storing in the respective removable storage media drive. These modules are shown respectively in FIG. 4.

To create or edit a graphic display, one simply calls up the respective module which then calls up the respective standard paint program or other scanner software if an image is intended to be scanned in as a password image. When the password image is finalized, the image is then downloaded utilizing the store/download module and the image is stored. In particular, an image can be the same image and same password image for both the computer and the keypad device or it can be two separate images. The desired password image is stored in the desired location in the keypad device non-volatile memory, and the computer password is stored in the computer hard drive or other permanent means. In the preferred mode, these stored images are stored in a non-typical format (other than bitmap, TIFF, etc.) so as to reduce the possibility of discovery by third parties. The images are ultimately compared, pixel for pixel.

The respective passwords are also stored on the respective floppy (keypad floppy and computer floppy). It should be kept in mind that any floppy as used herein refers to any removable storage medium device.

The user then removes the two floppies, or if desired, the same floppy can be used for both the keypad device and the computer.

However, in the preferred mode, it should be understood that each password consists of a series of images and the store/download module provides for creating a desired recall of the sequences of the images of that must be repeated upon sign in to successfully log on. It should also be understood that during the download process, each image is assigned to a separate key selected by the user on the respective keypad or keyboard. For example, a user wanting to use a photograph of their child and their pets, or a personal doodle or scribble will store them as separate images and assign them during the download process to their respective key on the keypad and this sequence must be remembered inasmuch as the keypad memory also recognizes the proper sequence. If the user selected keypad number 8 to represent the pet, keypad number 7 to represent the personal doodle and keypad number 2 to represent the scribble, the proper sign in sequence would then be 8, 7, 2.

When turning the computer on or signing in, the user is brought to the initialize/recognize module menu prompting the user to enter into the computer the respective proper code and sequence. The same process is used for the keypad wherein the keypad display prompts the user to insert the floppy “key” which contains the images, as does the floppy “key” for the computer, and the keypad prompts the user to insert the proper sequence on the keypad. If the proper password and sequence is provided, and after a pixel by pixel comparison, the keypad sends a Grant Access Signal (GAS) to the computer via the standard USB (or other desired port), satisfying condition 1 for the computer to allow access to the user. Condition 2 is met if the proper image code and sequence is entered into the computer keyboard. It should be noted that either the keypad password device or the computer password device may be entered first, although in the preferred mode, the order of entry would be to enter the computer password first. It should also be noted that the computer password can be an alphanumeric password. Consequently the entire invention allows for a unique combination of image and alphanumeric passwords to be used at the user's discretion.

If the password in the keypad device is not valid, the following sequence occurs: the user is prompted by the keypad display if the login failed, and the count for maximum retries is incremented, a check for maximum login attempts is performed and if the total number of login tries for the current login session is less than or equal to the maximum login tries allowed, the user is prompted by the keypad display to retype the password, restarting the process. However, if the total number of login tries is more than the maximum number of login tries allowed, the user is denied access for a pre-designated period of time. This predesignated period of time is designated by the user in seconds, minutes, hours or other period, at the time of installation of the program, and this particular number resides in permanent memory on the keypad device.

The processor executes the program and directs the input and output that occurs with the input/output device, the media device, keypad display and keypad interface, along with various keypad memories. After access has been granted, the keypad device can be powered down and unplugged.

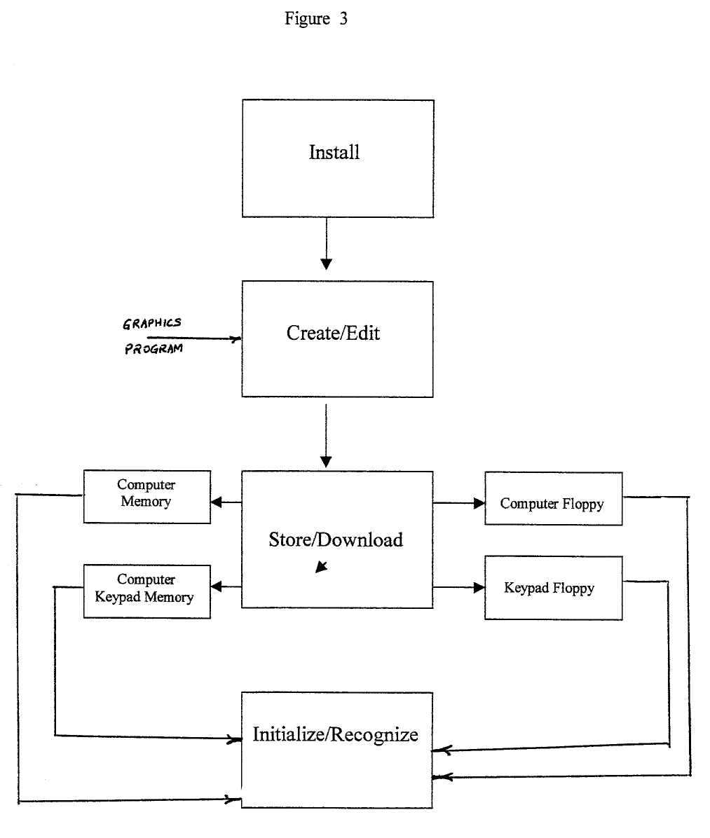

The process described is as set forth in FIGS. 3 and 4.

In another mode of the invention, the keypad device operates alone and independently without the need for a computer password. However, in the preferred mode, the addition of the computer password process enhances the security of the program.

Consequently, what is disclosed is a method and apparatus for providing a highly secure process and environment for a computer in/or network and allows the user a much broader range of passwords in the form of user defined graphic images so as to allow far more creative passwords, reducing chances of unauthorized access, and further provides for all of the above utilizing commonly available graphic programs including paint and scanner programs.

While there have been shown and described particular embodiments of the invention, it will be obvious to those skilled in the art that changes and modifications may be made without departing from the invention or its equivalent, and, therefore, it is intended by the appended claims to cover all such changes and modifications as fall within the true spirit and scope of the invention.

I claim:

1. A method for creating unique image passwords utilizing a separate keypad in conjunction with a universal computer system, to secure and gain access to a computer system comprised of a computer having a CPU, memory means, non-volatile memory storage, keyboard removable storage means, keypad with removable storage means and memory means, software for creating graphical images, and said system having a monitor capable of displaying graphics, said method comprised of the steps of:
a. Installing a computer residing program for controlling access to the computer so as to allow the computer to be disabled or enabled in response to a directive;
b. Creating the computer password digitized image utilizing the computer graphics program;
c. Storing said computer password digitized image in the keypad memory means;
d. Assigning the respective image password to a key on the keypad;
e. Storing the said computer digitized image on keypad removable storage means;
f. Inserting the keypad removable storage means when desired to operate the computer;
g. Inputting the numeric unique sequence code through the keypad;
h. Reading the image on the keypad removable storage means and comparing the image stored for a match, and comparing the unique numeric password with the stored numeric sequence associated with the respective graphic image, and granting access to the computer if a match is determined.

2. A method for creating unique image passwords utilizing a separate keypad in conjunction with a universal computer system, to secure and gain access to a computer system comprised of a computer having a CPU, memory means, non-volatile memory storage, keyboard removable storage means, keypad with removable storage means and memory means, software for creating graphical images, and said system having a monitor capable of displaying graphics, said method comprised of the steps of:
a. Installing a computer residing program for controlling access to the computer so as to allow the computer to be disabled or enabled in response to a directive;
b. Creating the computer password digitized image utilizing the computer graphics program;
c. Storing said computer password digitized image in the keypad memory means;
d. Storing in the keypad memory means a unique numerical sequence code for recalling the digitized image password;
e. Storing the said computer digitized image on keypad removable storage means;
f. Inserting the keypad removable storage means when desired to operate the computer;
g. Inputting the numeric unique sequence code through the keypad;
h. Reading the image on the keypad removable storage means and comparing the image stored for a match, and comparing the unique numeric password with the stored numeric sequence associated with the respective graphic image, and granting access to the computer if a match is determined.

3. A method for creating unique image passwords utilizing a separate keypad in conjunction with a universal computer system, to secure and gain access to a computer system comprised of a computer having a CPU, memory means, non-volatile memory storage, keyboard removable storage means, keypad with removable storage means and memory means, software for creating graphical images, and said system having a monitor capable of displaying graphics, said method comprised of the steps of:
a. Installing a computer residing program for controlling access to the computer so as to allow the computer to be disabled or enabled in response to a directive;
b. Creating the computer password digitized image utilizing the computer graphics program;
c. Storing said computer password digitized image in the computer memory means and in the keypad memory means;
d. Storing in the computer removable storage means the computer digitized image, and storing the digitized image on the keypad removable storage means;
e. Storing in the computer memory means and the keypad memory means a numerical sequence code for recalling the digitized image password;
f. Inserting the keypad removable storage means into the keypad, when desiring to operate the computer, and inserting the removable storage means having thereon the computer digitized image password, and inputting into the keypad the respective numerical sequence code associated with the digitized image password;
g. The digitized image stored in the computer memory means with the digitized images on the keypad removable storage means and computer removable storage means for a match, and if a match is obtained, comparing the unique numeric password entered on the keypad to determine if a match exists for the respective computer digitized password just matched, and granting access to the computer if a match is determined.
